(19) United States
(12) Patent Application Publication
(10) Pub. No.: US 2023/0360060 A1
(43) Pub. Date: Nov. 9, 2023

(54) Expedited Method of Quantifying Reduction of Wildfire Related Emissions to Enable Revenue Generation

(71) Applicant: Valentin Luca, East Greenwich, RI (US)

(72) Inventor: Valentin Luca, East Greenwich, RI (US)

(21) Appl. No.: 18/142,890

(22) Filed: May 3, 2023

Related U.S. Application Data
(60) Provisional application No. 63/338,624, filed on May 5, 2022.

(51) Int. Cl. G06Q 30/018

(52) U.S. Cl. CPC G06Q 30/018

(57) ABSTRACT

A method for quantifying the reduction of wildfire related emissions is designed to offer a basis for generating revenues by business willing to engage in fighting climate change by reducing the wildfire related emissions over a territory. The quantifying method is transparent and objective and is based on widely accepted data and forecasts, such that emissions reductions calculated with the disclosed method are certifiable to be traded on carbon markets. The quantifying method may be expeditiously applied to any territory.

### CROSS-REFERENCE TO RELATED APPLICATIONS

This application claims the benefit of U.S. Provisional Patent Application No. 63/338,624, filed May 5, 2022. The entire content of the foregoing provisional application is incorporated herein by reference.

### BACKGROUND

### 1. Technical Field

The disclosed method is designed to help fight climate change. It answers the need for a method of quantifying the reduction of wildfire-related emissions achieved by entities engaged in wildfire fighting at a time when wildfire activity is predicted to increase and enhance climate change over the next decades.

The lack of an appropriate quantifying method, simple and widely applicable, for emissions prevented by wildfire suppression, and which meets the certification criteria for trading the CO2 reduction on the carbon markets represents a major barrier to entry for businesses considering developing or operating wildfire fighting systems.

Thus, the present invention discloses a method for quantifying the reduction of wildfire related emissions from a defined territory over a given period.

From an application standpoint, the disclosed method generally applies to defined territories and to wildfire fighting systems with the ability to produce quick results, typically visible within a one year period. Such wildfire fighting systems could include suppression activities as well as prevention activities such as: fire management, thinning, setting firebreaks and the like. It is not recommended for slow land management practices such as afforestation or the like.

The disclosed method is based on objective measurements and on widely accepted data and scientific studies. The disclosed method is transparent and objective as required for certifying the quantity of reduced emissions for trading on the carbon markets.

Based on its reliance on widely accepted, readily available data, the disclosed method could be inexpensively and expeditiously applied.

### 2. Background Art

Currently, at 1.1° C. global temperature rise above the pre-industrial level, wildfires add each year 8 billion tons of CO₂ to the anthropogenic 41 billion tons. The massive amount of wildfire emissions creates a climate change accelerating feedback loop.

As the global temperature continue to increase towards 1.5-2.5° C. above the pre-industrial level, wildfires will be a growing problem and will continue to be a problem long after reaching net-zero.

Currently, there is no existing wildfire suppression technology capable of stopping the chain of high-intensity wildfire disasters, and much less a system with the efficiency and range required for a system to be an effective tool for fighting climate change. Reducing wildfire-related emissions is still an untapped domain.

In theory, technologies could offer the basis to develop an effective suppression system capable of reducing a substantial portion of wildfire-related emissions. However, there is no appropriate method to incentivize the industry and attract the investment towards developing and deploying such a system.

Trading the quantity of reduced wildfire-related emissions, hereinafter “emissions reduction”, on compliance markets and/or on voluntary carbon markets could be a strong incentive. In this context, quantifying emissions reduction is a key enabling factor.

Besides meeting the general conditions perISO14060/2019 group of standards, to be usable for carbon certification and trading, a quantification method should also be transparent and, in this context, simplicity is key. Simplicity would also potentially make the quantification method widely accessible and expeditiously applicable by businesses involved in reducing wildfire-related emissions.

One carbon certification organization, Verra (Washington, D.C.; verra.org), developed a method for evaluating the avoided forest degradation through fire management. The Verra methodology is not aimed at firefighting-related issues, but it still involves quantification of wildfire and decay emissions.

The Verra method requires a detailed definition of the studied area: e.g., biomass in different stratums, climate, types of fire, fire management actions, etc. Due to complexity, the Verra model is transparent only to the scientific community.

Additionally, applying such a model to a new area takes time; it cannot be expedited due to the required amount pf input data and research required for recalibrating the model. Under a “Code Red for Humanity”, any action that would contribute to fighting climate change must be expedited.

The complexity of such a model as developed by Verra discourages even the large aerospace and defense companies from investing their expertise in solving the wildfire issue.

The present disclosure provides a method that addresses the shortcomings and limitations of existing methods and supports essential efforts for reducing carbon emissions. These and other advantageous features and functions of the disclosed methods will be apparent from the detailed description which follows.

### SUMMARY

The disclosed method of quantifying the reduction of wildfire related emissions is designed to offer a basis for generating revenues by business(es) willing to engage in fighting climate change by reducing the wildfire related emissions over a territory.

The disclosed quantifying method is transparent and objective. It is based on widely accepted data and forecasts such that the emissions reduction calculated with the disclosed method are certifiable to be traded on carbon markets.

The disclosed quantifying method could be expeditiously applied to any territory. Additional features, functions and benefits of the disclosed methods will be apparent from the detailed description which follows.

### BRIEF DESCRIPTION OF THE FIGURES

To assist those of skill in the art in making and using the disclosed method, reference is made to the accompanying figures wherein:

FIG. 1 is a block diagram of an exemplary computing device for executing embodiments of the bypass application to implement a security bypass environment.

FIG. 2 is an exemplary client-server environment for executing embodiments of the bypass application to implement a security bypass environment.

### DETAILED DESCRIPTION

The disclosed method of quantifying emissions reduction, “Qr”, by a firefighting system is associated with a defined territory and a given period over which the wildfire fighting system(s) is/are used.

In the following, wildfire fighting systems are understood to be the ones producing results relatively quickly, typically within a one year period. Such systems may include, besides suppression, prevention activities such as: fire management, thinning, setting firebreaks and the like.

The disclosed method of calculating the Quantified Reduction (Qr), hereinafter “quantifying method”, by a firefighting system is associated with a defined territory and a defined period over which a wildfire fighting system operates. The disclosed quantifying method is applicable for territories large enough for statistics to work and for a minimum of one-year periods.

The quantity of emissions reduction is, by definition, the difference between what would be the quantity of emissions in the absence of the wildfire fighting system, hereinafter “baseline emissions”, “Qb”, and the actual quantity of emissions, hereinafter “actual emissions”, “Qa”, while the applicable wildfire fighting system is used over the defined territory and during the defined period.

The collateral emissions, “Qc”, generated by the related investments and by operating the wildfire fighting systems themselves, plus the ones induced in supporting sectors, are small in comparison with the prevented emissions and it may not have relevance in most of the cases. Still, adding little complexity for the sake of a conservative approach, Qc could be calculated and subtracted from Qr, such that only the net reduction Qn is certified. Calculating Qc with a generally accepted precision fits into common practice, and it is ancillary to (although potentially implemented with) the disclosed quantifying method.

Hence, the precision of quantifying Qr, or Qn, by the disclosed method is determined by the precision of the terms Qa, Qb.

In the disclosed method, Qa is based on data acquired by satellites. The global wildfire emissions are permanently monitored by satellites and periodically reported. The widely accepted Global Fire Emissions Database (GFED) or Copernicus Atmosphere Monitoring Service* (CAMS) are such examples. When applied to large territories, a medium resolution of such system, 500 m pixel, is usable by the disclosed method and Qa is inexpensively and expeditiously obtainable as a subset data by selecting from wildfire emissions databases, like GFED or CAMSA, only the data that belongs to the defined territory t and period p, said subset being referred as “Stp”.

For this purpose, annual reporting is quite appropriate (although the present disclosure is not limited by or to such frequency of reporting).

The precision of Qa is equal to the precision of the used wildfire emissions database for practical purposes; hence, if the database that is accessed/used in implementing the disclosed method is widely accepted, so will be the Qa value calculated/extracted from it.

Qb raises an issue since it equates with quantifying something that could—but did not—happen. Once fires are put out, a determination as to how long the fires could have lasted, how much the fires could have spread, and/or how many emissions could have been released, are difficult and time consuming to estimate. Modeling such a scenario requires a large data set, including detailed knowledge of the biosystem in the area, and irrespective of its sophistication, in the end, the results are still debatable.

In the disclosed quantification method, Qb is based on the same database as Qa. This facilitates efficiency/ease of operation and it also eliminates the conversion errors inherent in using different systems and/or datasets for Qa and Qb.

The difference is that, while Qa is directly obtainable from the data subset Stp corresponding to the defined territory t and period p, Qb is derived by a function based on a data subset Sth corresponding to the same territory t, but for previous periods h (history). Briefly, Qb is an extrapolation to the defined period p of the historic emission data h collected prior to applying firefighting on the specified territory t.

The same as in the case of Qa, in exemplary implementations of the present disclosure, the precision of the Stp, Sth datasets are widely accepted as subsets of one of the databases widely used in monitoring wildfire emissions.

Hence, the overall precision of Qb, and of the disclosed quantifying method depends on the method of deriving Qb from the historical data.

It is interesting to note that Qb is similar to the cap in a cap-and-trade system. Nature sets the cap for itself, and rational, scientific models approximating it are objective in comparison, for instance, with deciding on a cap for a coal-fired powerplant where subjective socioeconomic and politic considerations play key roles.

The methods of deriving Qb disclosed herein are intended to offer a solid base for reaching an agreement with regulators, carbon trading certification organizations, or the like organizations. It is expected that, during the process, the disclosed methods may suffer adjustments or clarifications.

The essence of this disclosed quantifying method is in the reliance on widely used databases as the ones for monitoring world's wildfire activity and methodological databases, eliminating discussions on accuracy of measurements.

Hence, in a practical application, agreeing with carbon trading regulators and certification organizations on a new project for reducing wildfire emission over a territory would focus only on agreeing on the objective Qb derivation.

Disclosed hereinbelow are four practical examples of deriving Qb: Qb1, Qb2, Qb3, Qb4, each one usable in a practical application of the disclosed quantifying method, depending on the specifics of the project, territory, length of project, year-to-year fluctuations, precision required by regulators or desired by operators of wildfire fighting systems.

In its simplest form, Qb1=En, where En is a constant equal to the n-year average quantity of yearly emissions over the subject territory, where n could be, e.g., 5 . . . 10 or d years prior to applying the firefighting systems to be evaluated, where d is counted from the first year the used data bases became available.

Applied to a multi-year agreement, a constant Qb1, puts the wildfire fighting system operators at disadvantage since it doesn't model the increasing wildfire activity with time as the global temperature continue to increase.

The increased fire activity could be represented by a function of the general form: Qb2=En*A(p) where A(p) is a dimensionless factor expressing the increase of fire activity in respect to En for each yearly quantification period p for the p=1, 2, . . . m periods on which the function Qb2 is defined.

The recent data published during the UNEP proceedings in Nairobi, February 2022, offers a widely accepted base for defining A(p). The published data indicates an increase in wildfire activity by an average of: 12% by 2030, 27% by 2050, and 44% by 2100. For the purpose of the disclosed quantifying method, A(p) is calculated based on any function of variable time, A(time) that interpolates the forecasted increase of wildfire activity for the following decades as specified by the official UN published data, the values of A(p) being calculated at the end of each year-season for 1, 2, . . . m periods.

If new, updated data became available, published by UN or not, as far as it is widely recognized, the updated data could be used following the same as the disclosed principles.

Under Qb1 or Qb2 derivations, a low fire activity during a period p will overestimate the quantified emission reduction for that period, while a high fire activity will underestimate it. Hence, while A(time) described above gives a trusted average trend of wildfire activity, the parties involved in carbon trading may opt for a quantification that accounts for the year-to-year fluctuations in fire activity.

The fluctuations-adjusted baseline, Qb3 takes into account the year-to-year weather fluctuations that could influence the baseline in the absence of an active firefighting system.

From the weather parameters, a limited number w of parameters, relevant for fire activity are selected, hereinafter fire conditions parameters, P1 . . . Pi . . . Pw which could include among others, the average temperature, average precipitation, relative humidity, lighting activity, maximum temperature, and the like, data obtainable from generally available weather reports. The parameters Pi may also include data obtained by simple measurements in the territory, e.g. maximum vegetation dryness.

The fluctuations-adjusted baseline emissions Qb3 is equal to En+S1*ΔP1+ . . . Sw*ΔPw where S1 . . . Sw are constants representing the sensitivities of wildfire emissions, hereinafter “sensitivities”, to the corresponding fire conditions parameters P1 . . . Pw and ΔP1 . . . ΔPw represent the variations of the relevant fire conditions parameters in respect to their historic average values for the defined territory.

A sensitivity Si is calculated based on historical data, as the variation of the emissions in respect to the historic average quantity of wildfire emissions En over the defined territory, ratioed to the variation of the respective fire conditions parameter ΔPi in respect to its historic average, while theoretically the other fire conditions parameters remain unchanged, what in mathematics is referred as a partial derivative.

Si*ΔPi terms represent the partial effect of the variation of fire conditions parameter Pi, hereinafter “partial effect”, determined by multiplying the actual deviation ΔPi of the fire conditions parameter in respect to its historic average multiplied with its respective sensitivity, what in mathematics is referred as linear approximation.

The fluctuation-adjusted baseline is derived simply by adding to the baseline emissions the sum of all the partial effects of the fire conditions parameters over defined territory and defined period.

To be noted that trends are also accounted into the derivation of Qb3; the global trend as described above in relation with QB2 is transparently accounted by Qb3 as the long trend is automatically included in the temperature fluctuation.

Based on the same principles as the ones described herein in the example of calculating Qb3 the persons skilled in the art may use alternate mathematical methods for calculating Qb3. Nonlinear modeling could be used too. Nonlinear may be thought as yielding a higher precision since the sensitivities are not constants, but themselves function of the related parameters Pi or of their deviation ΔPi.

As artificial Intelligence, AI, becomes widely used, it comes naturally to be applied to calculating Qb. AI could be used for determining the sensitivities Sj described above or for directly calculating the hypothetical emissions Ep over the defined territory, during the period p in absence of a wildfire system operating over that territory during the period p. The directly calculated Ep is referred herein after as Qb4.

The function F4 used to calculate Qb4=F4(p) for the period p is determined by machine learning based on the historical data, more specifically based on the historical yearly data sets of emissions outputs Ei where i=1 . . . n and the associated input which is the meteorological and field data sets for each particular year (P1, P2, . . . Pw)i where i=1 . . . n. Qb4 is then obtainable from the same machine-determined algorithm run for the data set (P1, P2, . . . Pw)p corresponding the subject period p.

The transparency may be affected by the use of AI, but it may be compensated by demonstrating the precision of the machine-determined algorithm. Demonstrating the precision of the machine determined-algorithm is possible by comparing output emissions Eci calculated for different historical periods i and input datasets (P1, P2, . . . Pw) with the actual emissions Eai corresponding to that period i.

Variations on methods of determining Qb can be done reflecting a preference of someone skilled in the art or as required by certification organizations.

Of note, the disclosed quantification method is advantageously based on readily available and widely accepted databases as global wildfire emissions databases and weather databases as WMO (World Meteorological Organization) and the like databases. It is counterintuitive that such quantification is made possible with no, or very little, data collected in the defined territory. This saves time, and considering that effective firefighting could reduce an important portion of the 22-million-ton CO₂ that is released daily to the atmosphere by wildfires, delays associated with a search for higher precision are counterproductive.

Higher precision may even not be obtainable. A Verra-like method could be eventually developed to include wildfire suppression. However, the precision of methods involving detailed biomass data is affected not only by the complexity of the modeled phenomena, but also by the difficulty of collecting the required input data. The complexity of the model and the large amount of input data translate into a lower transparency. Not the least, the overall impact of a project is reduced by the time consumed by data acquisition and model calibration.

Below are some cases of practical applications of the disclosed quantifying method when several biasing factors are present on the general territory on which the reduction of wildfire emissions are quantified.

One typical example is applying the disclosed quantifying method on a territory that includes several communities, each one with their own individual firefighting capabilities. The disclosed quantifying method provides for a complete separation by not including in the defined territory the surfaces protected by community firefighters.

Similarly, if the territory includes some logging activity areas, those could be easily eliminated from the defined territory. The emission impact of deforestation is accounted differently.

One complex case could be when several unrelated operators of different wildfire fighting systems act on the same territory. Each one's share could be agreed based, e.g., on the contributed resources, eventually rated by each one's efficiency. The negotiated contribution share of each wildfire system operator could be more or less precise, but the sum of all contributions is strictly limited to Qa, hence eliminating the risk of any double accounting of the emission reductions.

The disclosed quantifying method is applicable to a large variety of business generating revenues in fighting climate change by fighting wildfires. It is irrelevant if the wildfire fighting system operators sell the quantity of reduced emissions on the carbon markets, or they are being paid by organizations or by governments selling and/or using the prevented emissions against their NDCs (national determined contribution).

This disclosed approach maximizes transparency and objectivity, it saves time and is accessible to any organization willing to engage in fighting climate change by reducing the wildfire related emissions.

Its transparency/simplicity of the disclosed quantifying method reduces the entry barriers for carbon emission reduction associated with firefighting and fire reduction efforts and investments.

The disclosed quantifying method can be modified to adjust to specific mathematics, or during the negotiation process with regulating or certification organizations or just by the user of such a method without departing from the core principles of the disclosed quantifying method.

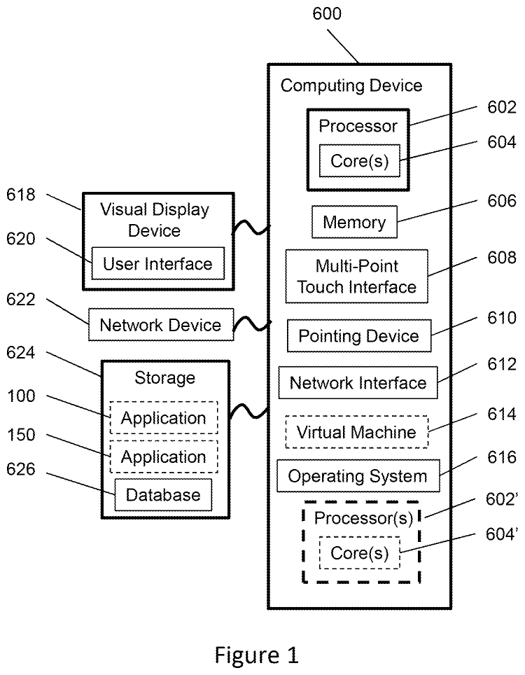

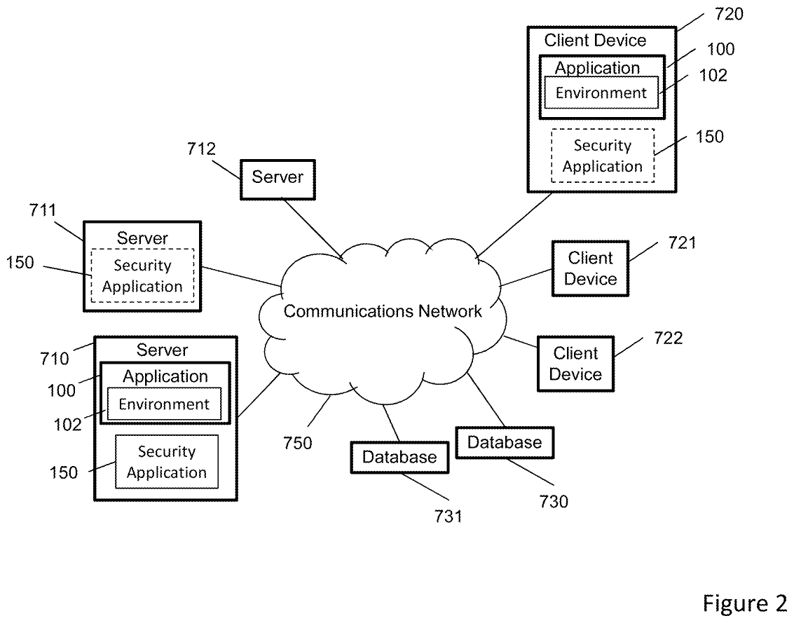

With reference to exemplary implementations of the disclosed method, reference is made to FIG. 1 and FIG. 2.

FIG. 1 is a block diagram of an exemplary computing device 600 that may be used to implement exemplary embodiments of the disclosed method. The computing device 600 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 606 included in the computing device 600 may store computer-readable and computer-executable instructions or software for implementing exemplary embodiments of the disclosed method. The computing device 600 also includes configurable and/or programmable processor 602 and associated core 604, and optionally, one or more additional configurable and/or programmable processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ may each be a single core processor or multiple core (604 and 604′) processor.

Virtualization may be employed in the computing device 600 so that infrastructure and resources in the computing device may be shared dynamically. A virtual machine 614 may be provided to handle a process running on multiple processors so that the process appears to be using only one computing resource rather than multiple computing resources. Multiple virtual machines may also be used with one processor.

Memory 606 may include a computer system memory or random access memory, such as DRAM, SRAM, EDO RAM, and the like. Memory 606 may include other types of memory as well, or combinations thereof.

A user may interact with the computing device 600 through a visual display device 618, such as a computer monitor, which may display one or more user interfaces 620 that may be provided in accordance with exemplary embodiments. The computing device 600 may include other I/O devices for receiving input from a user, for example, a keyboard or any suitable multi-point touch interface 608, a pointing device 610 (e.g., a mouse). The keyboard 608 and the pointing device 610 may be coupled to the visual display device 618. The computing device 600 may include other suitable conventional I/O peripherals.

The computing device 600 may also include one or more storage devices 624, such as a hard-drive, CD-ROM, or other computer readable media, for storing data and computer-readable instructions and/or software that implement exemplary embodiments of the application 100 described herein. Exemplary storage device 624 may also store instructions and/or software that implements the security application 150 and may also store one or more databases for storing any suitable information required to implement exemplary embodiments. For example, exemplary storage device 624 can store one or more databases 626 for storing information, such as information corresponding to one or more commands, operations, passcodes, user identifiers, and/or any other information to be used by embodiments of the disclosed method. The databases may be updated by manually or automatically at any suitable time to add, delete, and/or update one or more items in the databases.

The computing device 600 can include a network interface 612 configured and/or programmed to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 may include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 600 may run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 616 may be run in native mode or emulated mode. In an exemplary embodiment, the operating system 616 may be run on one or more cloud machine instances.

FIG. 2 is a block diagram of an exemplary client-server environment 700 configured and/or programmed to implement one or more embodiments of the environment 102 generated by the disclosed method. The environment 700 includes servers 710-712 operatively coupled to clients 720-722, via a communication network 750, which can be any network over which information can be transmitted between devices communicatively coupled to the network. For example, the communication network 750 can be the Internet, Intranet, virtual private network (VPN), wide area network (WAN), local area network (LAN), and the like. The environment 700 can include repositories or database devices 730, 731, which can be operatively coupled to the servers 710-712, as well as to clients 720-722, via the communications network 750. The servers 710-712, clients 720-722, and database devices 730, 731 can be implemented as computing devices. Those skilled in the art will recognize that the database devices 730, 731 can be incorporated into one or more of the servers 710-712 and/or clients 720-722 such that one or more of the servers can include databases.

In some embodiments, the disclosed method can be implemented by a single device, e.g., the server 710 or client 720, and can be accessed by other devices on the network 750, e.g., the servers 711-712 and/or clients 721-722. In some embodiments, the application 100 can be distributed among different devices (e.g., servers, clients, databases) in the communication network 750 such that one or more components of the disclosed method, or portions thereof, can be implemented by different devices in the communication network 750.

In an exemplary operation, the devices on the communications network (e.g., servers 710-712, clients 720-722, databases 730-731) can be governed by an enterprise security application 150, which can be implemented by servers 710, 711, and/or client 720. In the present embodiment, an application for implementing the disclosed method can reside on the server 710 and can be remotely executed by clients 720-722 via the communications network 750. Upon execution of the disclosed method by, for example, the client 720, the application 100 can implement the user interface 110 to render the GUI 112 on a display device of the client 720 and can generate the environment 102. A user interacting with the client 720 can submit a request including one or more operations to be performed and a passcode, as described herein, through the GUI 112, which can be processed in the environment 102 generated by the disclosed method. Upon processing the request, the disclosed method can instruct the server 710 to perform one or more access controls. For example, the disclosed method can instruct the server to construct a query to retrieve a stored passcode associated with the user of the client 720 from the database 730 and compare the passcode included in the request with the stored passcode. Additional access controls can be performed as described herein. Upon satisfaction of the access controls, the one or more operations included in the request can be performed by the server 710 and/or the client 720. For example, the user can install and/or execute one or more untrusted software applications through the environment 102 using a processing device associated with the server 710 and/or the client 720.

Although the present disclosure includes descriptions of advantageous implementations of the disclosed methods, the present disclosure is not limited by or to such exemplary implementations. Rather, the methods of the present disclosure are susceptible to various modifications, revisions and/or enhancements without departing from the spirit or scope of the present invention.

1. A method for reducing carbon emissions associated with wildfires, comprising:
a. quantifying reduction of wildfire emissions from a defined territory over a defined period of time based on implementation of one or more wildfire fighting systems;
b. utilizing the quantified reduction of wildfire emissions to reward implementation of the one or more wildfire fighting systems.

2. The method of claim 1, wherein the quantifying step is objective and transparent to users thereof.

3. The method of claim 1, wherein the quantifying step is based on one or more assumptions and on publicly available data.

4. The method of claim 1, further comprising certification of the quantified reduction of wildfire emissions by a certifying agency.

5. The method of claim 1, wherein the reward for implementation of the one or more wildfire fighting systems is selected from the group consisting of (i) trading of the quantified reduction of wildfire emissions, (ii) monetization of the quantified reduction of wildfire emissions based on payment(s) from one or more entities or organizations using the quantified reduction of wildfire emissions in satisfaction of national determined contributions (NDCs), and (iii) combinations thereof.

6. The method of claim 1, wherein the quantifying step calculates the difference between (i) an estimated quantity of emissions in the absence of the implementation of the one or more wildfire fighting systems (Qb), and (ii) the actual quantity of emissions after the implementation of the one or more wildfire fighting systems (Qa).

7. The method of claim 6, further comprising inclusion of collateral emissions (Qc) in the quantifying step.

8. The method of claim 6, wherein the actual quantity of emissions after the implementation of the one or more wildfire fighting systems (Qa) is based on data acquired by satellites.

9. The method of claim 6, wherein the estimated quantity of emissions in the absence of the implementation of the one or more wildfire fighting systems (Qb) is based on data acquired by satellites.

10. The method of claim 8, wherein the data acquired by satellites is accessed from a publicly available database (e.g., the Global Fire Emissions Database (GFED)).

11. The method of claim 9, wherein the estimated quantity of emissions in the absence of the implementation of the one or more wildfire fighting systems (Qb) includes a time-based function.

12. The method of claim 6, further comprising determination of a fluctuations-adjusted baseline emissions value (Qb3).

13. The method of claim 12, wherein the fluctuations-adjusted baseline emissions value (Qb3) is equal to En+S1*ΔP1+ . . . Sw*ΔPw,
wherein S1 . . . Sw are constants representing sensitivities of wildfire emissions to corresponding fire conditions parameters P1 . . . Pw, and
wherein ΔP1 . . . ΔPw represent variations of relevant fire conditions parameters in respect to their historic average values for the defined territory.

14. The method of claim 13, wherein the sensitivities of wildfire emissions are based on historical data as the variation of the emissions in respect to the historic average quantity of wildfire emissions En over the defined territory, ratioed to the variation of the respective fire conditions parameter ΔPi in respect to its historic average.

15. The method of claim 13, wherein the Si*ΔPi term represents the partial effect of the variation of fire conditions parameter Pi determined by multiplying the actual deviation ΔPi of the fire conditions parameter in respect to its historic average multiplied with its respective sensitivity.
